(19) United States
(12) Patent Application Publication
(10) Pub. No.: US 2026/0336862 A1
(43) Pub. Date: Oct. 29, 2026

(54) SYSTEM AND METHOD OF BOX-BLANK AND LINER COMBINATION PACKAGING

(71) Applicant: David Hengami, Torrance, CA (US)

(72) Inventor: David Hengami, Torrance, CA (US)

(73) Assignee: Revobox Dispensing Technologies, LLC, Torrance, CA (US)

(21) Appl. No.: 19/099,157

(22) PCT Filed: Aug. 3, 2023
(86) PCT No.: PCT/US2023/071569

§ 371 Date: Jan. 28, 2025

Related U.S. Application Data
(60) Provisional application No. 63/395,062, filed on Aug. 4, 2022.

(51) Int. Cl. B65D 5/60; B31B 50/26; B31B 110/35; B31B 120/40; B65B 1/02; B65D 5/70

(52) U.S. Cl. CPC B65D 5/603; B31B 50/262; B65B 1/02; B65D 5/705; B31B 2110/35; B31B 2120/40

(57) ABSTRACT

A blank and liner combination for forming a box, comprising a blank having a plurality of foldably connected panels, an inside surface, an outside surface, and at least one dispensing opening disposed in at least one of the panels, and at least one liner coupled to the inside surface of the blank. A system for forming a box with an integrated liner, the system comprising at least one blank feeder machine, at least one conveyor belt, at least one liner affixing machine, at least one fold and form machine, and at least one fill machine. A method of forming a box with an integrated liner, the method comprising the steps of a) providing a blank, b) providing at least one liner, c) coupling the liner to the blank, forming a blank and liner combination, and d) sealing, folding and forming the blank and liner combination to form the box.

### CROSS-REFERENCE TO RELATED APPLICATIONS

This US 371 national phase application claims priority to PCT Application No. PCT/US2023/71569, titled “System and Method of Box-Blank and Liner Combination Packaging,” filed Aug. 3, 2023, which claims priority to United States Provisional Patent Application No. 63/395,062, titled “System and Method of Box-Blank and Liner Combination Packaging,” filed Aug. 4, 2022, the contents of which are incorporated by reference herein in their entirety.

### BACKGROUND

High speed manufacturing and filling of cereal boxes, or any other type of box where a liner is necessary to package the contents, is limited by the speed at which the filling machines can load the filled bags of product into the formed boxes. Moreover, this traditional method of forming and filling will not work with boxes that have dispensing openings.

More specifically, known liners and boxes must be formed separately, either on different production lines, or at different times on the same production. But in either case, they are not formed at the same time because the liner is flexible and the blanks used to form the boxes are rigid and their different forms require different machines to get formed as a ready box. And when it comes time to place the filled liners into the formed boxes, typical production lines, in order to keep production speeds as high as possible, have multiple machines running at the same time that place the filled liners in the formed boxes.

Accordingly, there is a need for a) a liner and blank combination that can be formed and filled simultaneously, b) a single system for forming and filling the liner and blank combination that allows cereal boxes and the like to be formed, filled and sealed at a greater speed, and c) a method of using the same, particularly for boxes with side/top dispensing apertures that do not require the box top to be opened the liner bag to be torn to access the contents.

### SUMMARY

The present invention satisfies this need. In a first embodiment, the present invention is directed to a blank and liner combination for forming a dispensing box. The combination comprises a blank and at least one liner coupled to, or configured to couple to, the blank.

The blank has a plurality of foldably connected panels, an inside surface, an outside surface, and at least one dispensing opening disposed in at least one of the panels.

Optionally, the liner has at least one perforation zone configured to align with the at least one dispensing opening in the blank.

Optionally, the blank is made from paperboard.

Optionally, the blank comprises a first panel, a second panel foldably coupled to the first panel, the second panel having a top minor flap foldably coupled thereto, a third panel foldably coupled to the second panel, the third panel having a first dispensing opening disposed therein, a top major flap foldably coupled thereto, and a bottom major flap foldably coupled thereto, a fourth panel foldably coupled to the third panel, the fourth panel having a top minor flap foldably coupled thereto, and a bottom minor flap foldably coupled thereto, a fifth panel foldably coupled to the fourth panel, the fifth panel having a top major flap foldably coupled thereto, and a bottom major flap foldably coupled thereto, a sixth panel foldably coupled to the fifth panel, the sixth panel having a bottom minor flap foldably coupled thereto, a seventh panel foldably coupled to the sixth panel, and an eighth panel foldably coupled to the seventh panel.

Optionally, the top major flap of the fifth panel is foldably connected to a dispensing flap, wherein the dispensing flap has at least one second dispensing opening therein.

In a second embodiment, the present invention is directed to a system for forming a box with an integrated liner. The system comprises at least one blank feeder machine, at least one conveyor belt, at least one liner affixing machine, at least one fold and form machine, and at least one fill machine.

Optionally, the at least one liner affixing machine comprises at least one roll of rolled liner, at least one glue-dispensing system, and at least one application loop.

In a third embodiment, the present invention is directed to a method of forming a box with an integrated liner. The method comprises the steps of:
A) providing a blank, the blank having a plurality of foldably connected panels, an inside surface, an outside surface, at least one dispensing opening disposed in at least one of the panels;
B) providing at least one liner configured to be coupled to the inside surface of the blank, wherein the liner has at least one perforation zone configured to align with the at least one dispensing opening in the blank;
C) coupling the at least one liner to the inside surface of the blank, wherein the at least one perforation zone of the liner is aligned with the at least one dispensing opening in the blank, forming a blank and liner combination; and
D) sealing, folding and forming the blank and liner combination to form the box.

### DRAWINGS

These and other features, aspects, and advantages of the present invention will become better understood with regard to the following description, appended claims, and accompanying drawings.

FIG. 1 is a perspective view of a system and method of box and liner combination having features of the present invention;

FIG. 2 is a top plan view of a box and liner combination;

FIG. 3 is a perspective view of a first step of the system and method of FIG. 1;

FIG. 4 is a perspective view of a second step of the system and method of FIG. 1;

FIG. 5 is a perspective view of a third step of the system and method of FIG. 1;

FIG. 6 is a perspective view of a fourth step of the system and method of FIG. 1;

FIG. 7 is a perspective view of a folding step that takes place in FIG. 6;

FIG. 8A is a partial, perspective view of an additional folding step that takes place in FIG. 6;

FIG. 8B is a partial, perspective view of an additional folding step that takes place in FIG. 6; and

FIG. 9 is a perspective view of a fifth step of the system and method of FIG. 1.

### DESCRIPTION

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device/component or part of a device, and/or any additional devices as may be needed, disclosed in this disclosure will be determined by its intended use.

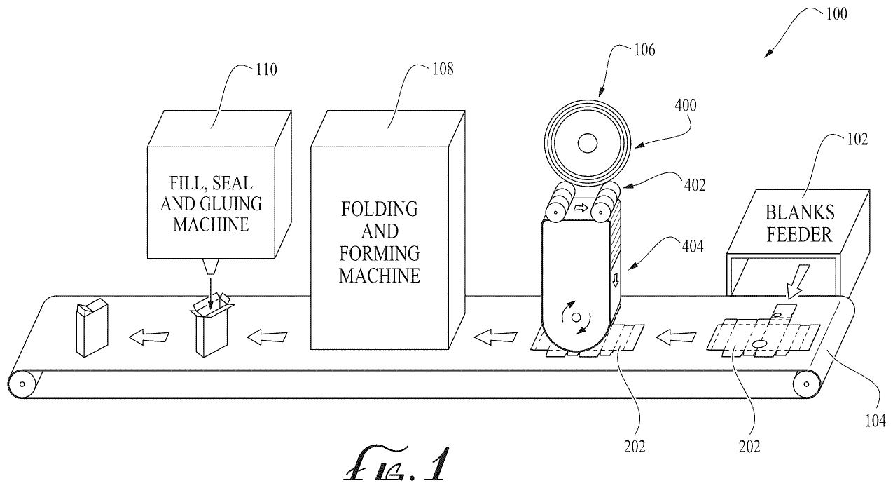

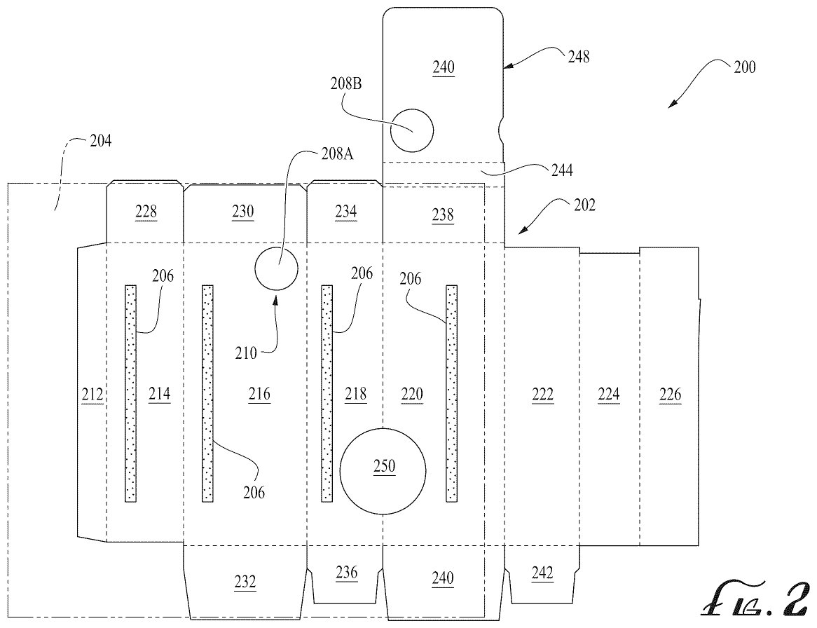

Referring now to FIG. 1, there is shown a system and method 100 for assembling a blank and liner combination 200 shown in FIG. 2, to form a box with a liner 904 therein. The system 100 comprises five main components: a blank feeder machine 102, a conveyor belt 104, a liner affixing machine 106, a fold and form machine 108 and a fill machine 110.

Referring now to FIG. 2, the blank and liner combination 200 is shown. The combination 200 comprises a blank 202 and a liner 204 adhesively coupled thereto by at least one adhesive patch/strip 206. Any number of adhesive patches/strips 206 can be used, and the patches/strips 206 can be in any configuration along the blank 202. The liner 204 can be any shape and configuration, but preferably, the liner 204 covers a substantial portion of its corresponding blank 202 so that it may properly function as a liner for the resulting box 904. The liner 204 can be made from a food-grade or food-safe plastic or biodegradable material that would typically be used as a liner for boxes that contain food products.

In the embodiment shown in FIG. 2, the blank 202 comprises eight longitudinally connected panels 212, 214, 216, 218, 220, 222, 224, 226. The second panel 214 has a top minor flap 228 foldably coupled thereto. The third panel 216 has a first dispensing opening 208A disposed therein, and a top major flap 230 and a bottom major flap 232 foldably coupled thereto. The fourth panel 218 has a top minor flap 234 and a bottom minor flap 236 foldably coupled thereto. The fifth panel 220 has a top major flap 238 and a bottom major flap 240 foldably coupled thereto. The sixth panel 222 has a bottom minor flap 242 foldably coupled thereto. The fourth and fifth panels 218, 220 can share at least one cutout window 250 which allows a user to view the contents of the box 904 without having to open the box 904. However, it should be noted that the at least one cutout window 250 can be positioned anywhere along the blank 202, and the placement of the window 250 is not limited to what is shown in the figures.

The top major flap 238 that is foldably coupled to the fifth panel 220 has two additional panel sections 244, 246 foldably coupled thereto, and panel section 246 has a second dispensing opening 208B disposed therein.

When folded into the box 904, third panel 216 forms the front panel of the box 904 and fifth panel 220 forms the rear panel of the box 904. Panel sections 244 and 246 fold down and into the box 904 and form the dispensing flap 248 that blocks and unblocks the first dispensing opening 208A by allowing a user to align and un-align the second dispensing opening 208B with the first opening 208A. When the first and second openings 208A, 208B are aligned, the contents of the box 904 can be dispensed from the box 904. When the openings 208A, 208B are not aligned, the contents of the box 904 cannot be dispensed from the box 904.

In FIG. 2, the blank 202 is shown to have a particular shape/configuration and a specific number of panels, but it should be appreciated that the blank 202 that is used as part of the combination 200 can be any shape and is not limited to the specific configuration shown in the figures. However, preferably, each blank 202 has at least one dispensing opening 208 therein.

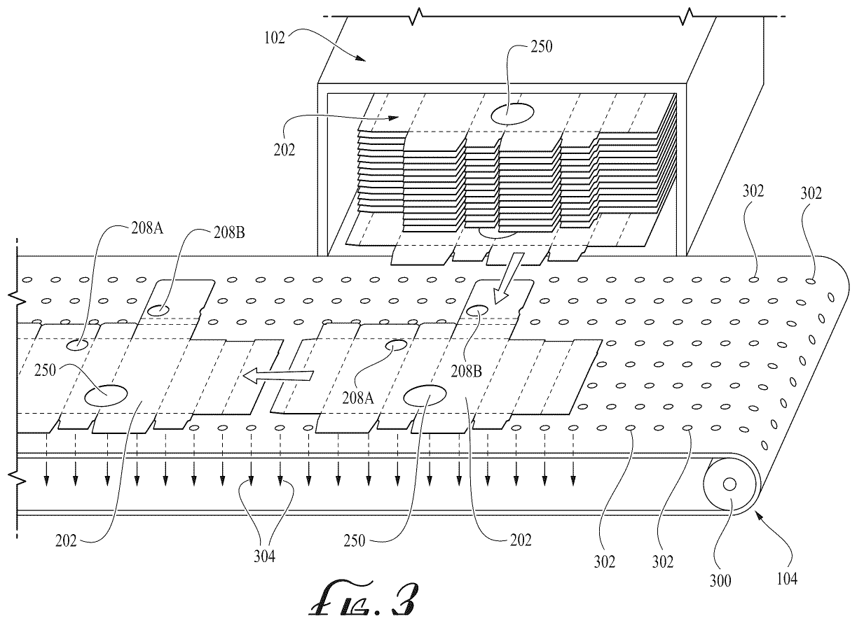

Referring now to FIG. 3, the system 100 starts with the automatic blank feeder machine 102. The blank feeder 102 is a standard blank feeder machine that is configured to feed paperboard blanks 202, typically one at time although it could be configured to feed multiple blanks 202 simultaneously, onto the conveyor belt 104. The blank feeder 102 can utilize a tray feeder, or one or more mechanical/robotic arms that lift and place the blanks 202 onto the conveyor belt 104. As noted above, the paperboard blanks 202 can have at least one dispensing opening 208 therein for dispensing or pouring product out of the fully formed box 904.

Optionally, the conveyor belt 104 is disposed around at least one roller 300 and can be perforated, having a plurality of holes 302 therethrough. One or more vacuum zones (supplied by at least one vacuum system) can be utilized such that vacuum/suction pressure 304 is applied to the underside of the belt 104 to suction down the blanks 202 to the belt 104 and help retain the blanks 202 in their proper position as they are transported by the belt 104.

Optionally, the belt 104 can utilize coordinated speed i-sensors along the belt 104 to ensure the liner 204 and blank 202 are properly located and timed.

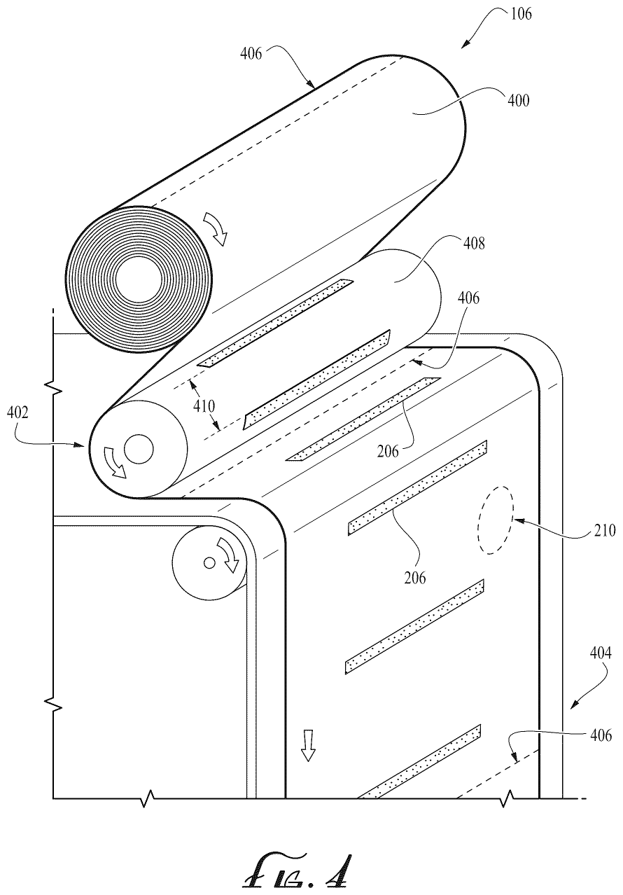

Referring now to FIGS. 4 and 5, once the blank 202 is on the conveyor belt 104, the conveyor belt 104 moves the blank 202 into position beneath the liner affixing machine 106. The liner affixing machine 106 has three main parts: one or more rolls of rolled liner/film 400, at least one glue-dispensing system 402, and an application loop 404.

The roll of liner/film 400 is an industry standard roll. However, the roll 400 can have perforations 406 where necessary to delineate one box liner 204 from the next, and to facilitate their separation when each box liner 204 is applied to its respective blank 202. Optionally, the roll of liner 400 is die cut to match the shape of the blank 202 to which it will be affixed, including any dispensing openings 208 in the blank 202.

The glue-dispensing system 402 comprises one or more rollers 408 with an appropriate glue-pattern thereon (pattern gluer) 410, such that as the liner 204 leaves the roll of liner 406 and passes over the roller(s) 408 of the glue system 402, the glue rollers 408 apply the appropriate glue pattern 206 to each liner sheet 204. It is important that the glue pattern 206 that is applied to each liner 204 does not interfere with the fold lines of the blank 202 and/or the dispensing openings 208 in the blank 202. Each liner 204 may have one or more perforation zones 210 that correspond to the one or more dispensing openings 208 in the blank 202. Typically, the glue pattern 206 will include having glue applied to each liner 204, around each perforation zone 210, on at least one, preferably two, sides of the perforation zone 210, so that each perforation zone 210 remains aligned with the corresponding dispensing opening 208 in the blank 202. Additionally, there should be at least one glue line or application 206 on the “side panels” of the liner 204 (at this point the liner 204 does not technically have side panels as it is simply a sheet of liner being affixed to the flat, unfolded blank 202) to ensure that each side of the liner 204 is affixed to each side panel of the blank 202 and the resulting box 904. The glue/adhesive 206 used should be food grade if food products are to be contained within the box 904.

The liner 202 with its glue pattern 206 applied, then continues down along the application loop 404, where it can then be applied to a blank 202 as the blank 202 passes underneath the loop 404. This is best shown in FIG. 5. The glue pattern 206 is an outside surface of the liner 204 such that it can be pressed up against, and bind to, the inside surface of the blank 202 (which is orientated upward to receive the liner 204) as it passes underneath the loop 404.

There can be at least one additional roller or wheel (a crushing roller) 500 positioned after the loop 404, along the belt 104, that applies pressure to the liner 204 on top of the blank 202 to ensure proper adhesion of the liner 204 to the blank 202. Optionally, the orientation of the loop of liner 404 and the blank 202 is not necessarily one on top of the other, and the blank 202 does not pass underneath the loop 404, but in an alternate direction/orientation that allows the liner 204 to be applied to the blank 202.

Next, the blank 202 with its glued liner 204 then continues along the conveyor belt 104 to the fold and form machine 108, and then, finally, the fill, seal and glue machine 110. While not shown in the figures, the fold and form machine 108, and the fill, seal and glue machine 110 can comprise the same machine, or be housed in the same the same housing (as opposed to two different machines/stations as shown in the figures).

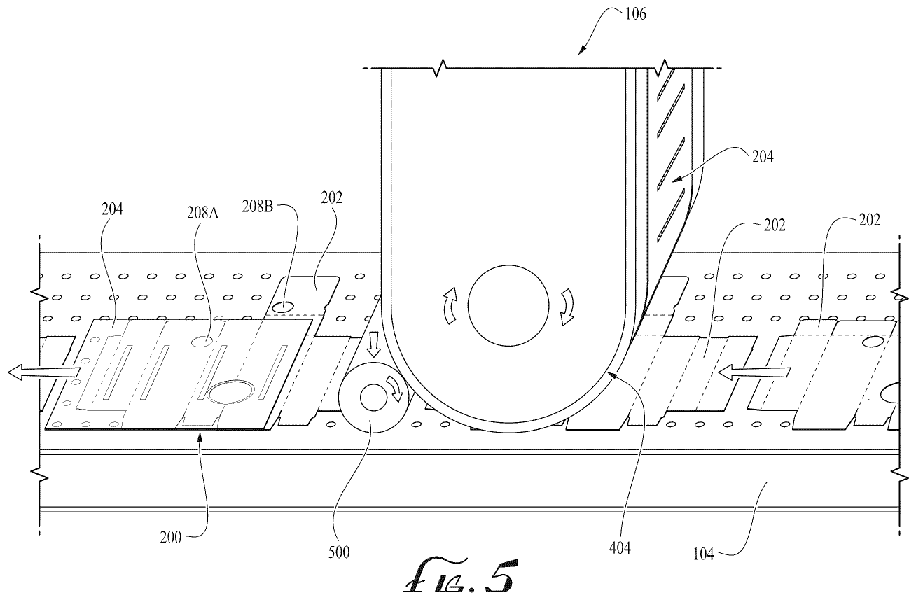

Referring now to FIG. 6, the fold and form machine 108 is shown in basic detail. The fold and form machine 108 folds and forms the blank and liner combination 200 into an open topped box/liner combination 600.

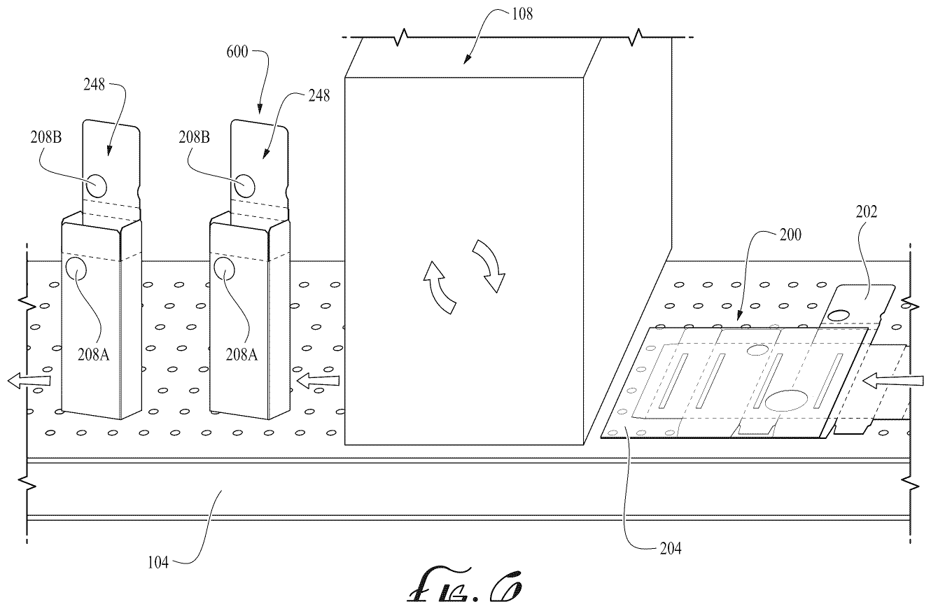

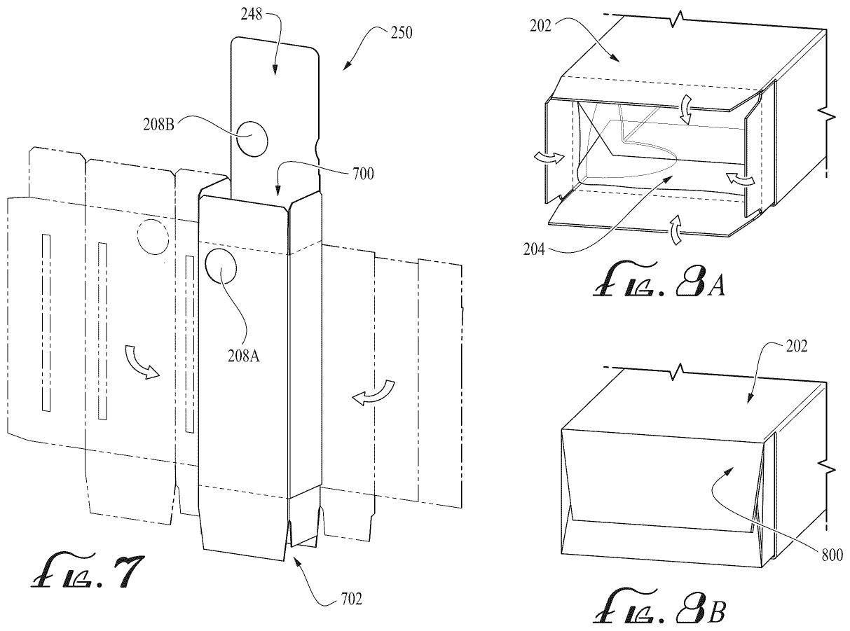

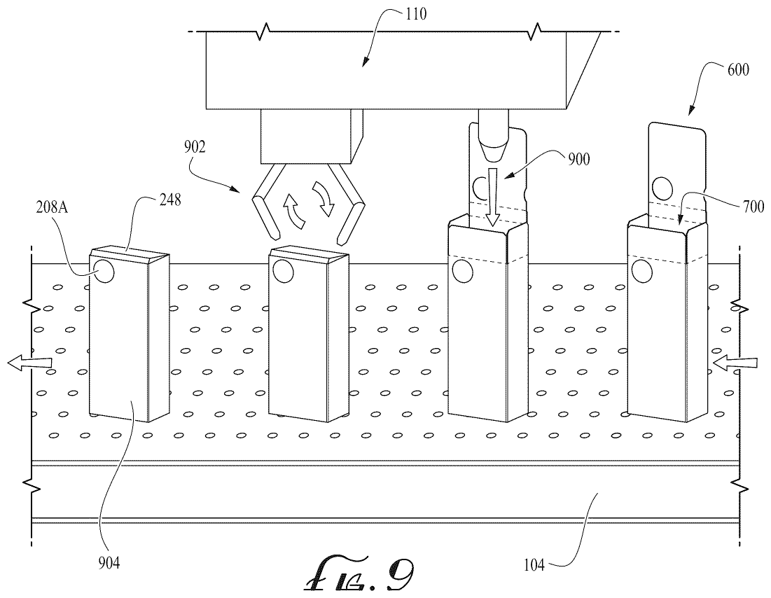

Referring now to FIGS. 7-8, the basic folding steps necessary to achieve the open topped box/liner combination 600 are shown. More specifically, the flat, unfolded, blank and liner combination 200 is folded to form a partially folded combination, wherein the side panels are folded forming an open top 700 and an open bottom 702. FIG. 7 shows this folding step. Next, the bottom of the liner 204 is sealed, and then bottom of the blank 202 is folded and glued 800, forming the closed bottom 800 of the combination 200. This is shown in FIGS. 8A and 8B. This forms the open topped box/liner combination 600 shown in FIG. 6, where the tops of both the partially folded blank 202 and the liner 204 are open and unsealed, but the bottoms of the liner 204 and the blank 202 are closed and sealed 800.

Referring now to FIG. 9, once the open topped box/liner combination 600 is formed, the conveyor belt 104 moves it to the fill, seal and glue machine 110. In this machine 110, the open topped box/liner combination 600 is positioned upright, with the open top 700 facing up. The machine 110 can then pour the contents 900 into the box/liner combination 600 via the open top of the box/liner 700. Once the contents 900 are in the box/liner combination 600, the top of the liner is heat sealed, and then the top of the box can be folded, formed and sealed/glued in the traditional fashion 902.

A plurality of sensors and or cameras can be used throughout the system 100 to ensure proper placement, positioning, and application of the blanks 202 and/or liners 204.

The present invention has many advantages. First, the standard way to fill a box with contents that require a liner requires the liner to be pre-filled and sealed, forming a loose, floppy pouch/packet of material. The act of sliding a floppy bag of material into a rigid box requires the filling machine to run at a much slower pace than the box forming machine. Thus, the manufacturing speed of products that require liners is limited by the speed at which the fill machine can feed the floppy bags of material into the preformed boxes.

The present invention addresses this issue by creating a blank/liner combination that can be folded into a box having a built-in liner, and this box with built in liner can be filled much faster than a box being filled with a floppy, pre-filled liner (the standard filling method). This is because loose material can be poured or fed into the open topped box with built in liner combination at a faster speed than floppy bags of material can be inserted into rigid boxes. Accordingly, the present invention results in a significant cost savings because the speed of filling can be increased, resulting in a higher output of product.

Moreover, it is typical to have one form and fold machine, and multiple liner filling machines. The present invention negates this need for multiple liner filling machines because the speed at which the system can fill is much faster, allowing the filling machine to keep a closer pace with the form and fold machine, thus reducing manufacturing costs even more.

An additional advantage is that the standard pre-filled liner/bag is much smaller than the box, and the box is always finished with a large amount of empty space to ensure the pre-filled liner bag can be placed therein. This wastes a large amount of paper/paperboard.

The present invention allows a reduction in wasted packaging material.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference.

What is claimed is:

1. A blank and liner combination for forming a box, comprising:
a) a blank having:
i) a plurality of foldably connected panels;
ii) an inside surface;
iii) an outside surface; and
iv) at least one dispensing opening disposed in at least one of the panels; and
b) at least one liner coupled to the inside surface of the blank.

2. The combination of claim 1, wherein the liner has at least one perforation zone configured to align with the at least one dispensing opening in the blank.

3. The combination of claim 1, wherein the blank is made from paperboard.

4. The combination of claim 1, wherein the blank comprises:
a) a first panel;
b) a second panel foldably coupled to the first panel, the second panel having:
i) a top minor flap foldably coupled thereto;
c) a third panel foldably coupled to the second panel, the third panel having:
i) a first dispensing opening disposed therein;
ii) a top major flap foldably coupled thereto; and
iii) a bottom major flap foldably coupled thereto;
d) a fourth panel foldably coupled to the third panel, the fourth panel having:
i) a top minor flap foldably coupled thereto; and
ii) a bottom minor flap foldably coupled thereto;
e) a fifth panel foldably coupled to the fourth panel, the fifth panel having:
i) a top major flap foldably coupled thereto; and
ii) a bottom major flap foldably coupled thereto;
f) a sixth panel foldably coupled to the fifth panel, the sixth panel having:
i) a bottom minor flap foldably coupled thereto;
g) a seventh panel foldably coupled to the sixth panel; and
h) an eighth panel foldably coupled to the seventh panel.

5. The combination of claim 4, wherein the top major flap of the fifth panel is foldably connected to a dispensing flap, wherein the dispensing flap has at least one second dispensing opening therein.

6. A blank and liner combination for forming a box, comprising:
a) a blank having:
i) a plurality of foldably connected panels;
ii) an inside surface;
iii) an outside surface; and
iv) at least one dispensing opening disposed in at least one of the panels; and
b) at least one liner configured to adhesively couple to the inside surface of the blank.

7. The combination of claim 6, wherein the liner has at least one perforation zone configured to align with the at least one dispensing opening in the blank.

8. The combination of claim 6, wherein the blank is made from paperboard.

9. The combination of claim 6, wherein the blank comprises:
a) a first panel;
b) a second panel foldably coupled to the first panel, the second panel having:
i) a top minor flap foldably coupled thereto;
c) a third panel foldably coupled to the second panel, the third panel having:
i) a first dispensing opening disposed therein;
ii) a top major flap foldably coupled thereto; and
iii) a bottom major flap foldably coupled thereto;
d) a fourth panel foldably coupled to the third panel, the fourth panel having:
i) a top minor flap foldably coupled thereto; and
ii) a bottom minor flap foldably coupled thereto;
e) a fifth panel foldably coupled to the fourth panel, the fifth panel having:
i) a top major flap foldably coupled thereto; and
ii) a bottom major flap foldably coupled thereto;
f) a sixth panel foldably coupled to the fifth panel, the sixth panel having:
i) a bottom minor flap foldably coupled thereto;
g) a seventh panel foldably coupled to the sixth panel; and
h) an eighth panel foldably coupled to the seventh panel.

10. The combination of claim 9, wherein the top major flap of the fifth panel is foldably connected to a dispensing flap, wherein the dispensing flap has at least one second dispensing opening therein.

11. A system for forming a box with an integrated liner, the system comprising:
a) at least one blank feeder machine;
b) at least one conveyor belt;
c) at least one liner affixing machine;
d) at least one fold and form machine; and
e) at least one fill machine.

12. The system of claim 11, wherein the at least one liner affixing machine comprises:
a) at least one roll of rolled liner;
b) at least one glue-dispensing system; and
c) at least one application loop.

13. A method of forming a box with an integrated liner, the method comprising the steps of:
a) providing a blank, the blank having:
i) a plurality of foldably connected panels;
ii) an inside surface;
iii) an outside surface;
iv) at least one dispensing opening disposed in at least one of the panels;
b) providing at least one liner configured to be coupled to the inside surface of the blank, wherein the liner has at least one perforation zone configured to align with the at least one dispensing opening in the blank;
c) coupling the at least one liner to the inside surface of the blank, wherein the at least one perforation zone of the liner is aligned with the at least one dispensing opening in the blank, forming a blank and liner combination; and
d) sealing, folding and forming the blank and liner combination to form the box.
